(19) United States
(12) Patent Application Publication
(10) Pub. No.: US 2008/0301538 A1
(43) Pub. Date: Dec. 4, 2008

(54) Method and Apparatus for Detecting Video Data Errors

(75) Inventors: Jin Wang, Shanghai (CN); Daqing Zhang, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V, Eindhoven (NL)

(21) Appl. No.: 12/095,173

(22) PCT Filed: Nov. 24, 2006
(86) PCT No.: PCT/IB2006/054413

§ 371 Date: May 28, 2008

(30) Foreign Application Priority Data
Dec. 2, 2005 (CN) 200510128943.3

(51) Int. Cl. G06F 11/00

(52) U.S. Cl. 714/819; 714/E11.002

(57) ABSTRACT

The present invention provides a method and apparatus for detecting video data errors, said video data including a plurality of successive frame image data, said method comprising the steps of acquiring the processing sequence information of two frame image data in said video data, said two frame image data being immediately adjacent in the processing sequence, one after the other, determining the processing sequence information difference between two frame image data, comparing said information difference with a reference value and judging, based on said comparison result, whether there is a frame image data miss between said two frame image data. The method and apparatus provided by the invention can, not only judge whether there is a frame image data missing between the two immediate adjacent frames, but also determine the amount of the missing frame image data and performs a restoring and correcting process.

### FIELD OF THE INVENTION

The present invention relates to data error correction, in particular to a method and apparatus for detecting video data errors.

### BACKGROUND OF THE INVENTION

Data missing is hard to avoid during the process of storing, reading and delivering the video data. For example, during reading video data from an optical disc, due to the factors like the quality of the optical disc reading means or optical disc, some frame image data (such as I-frame, B-frame or P-frame) of the video data may not be read, thereby resulting in a data missing. The frame image data missing will have a relatively serious impact on the video playing back effect, for example, the program can only be played back intermittently.

The prior art can restore the missing frame image data with reference to the corresponding data if it can detect the frame image data missing. For example, if B-frame or P-frame image data is missing, said image data can be restored to a certain extent by using the method of Motion Vector Estimation with reference to the corresponding I-frame image data, so that the programs on the optical disc can be played back smoothly.

In the prior art, the technical solution that is usually adopted to detect whether the frame image data is missing is implemented according to the type sequence of frame image data. A video data comprises a plurality of Group of Pictures GOP, whereas one GOP includes a certain amount of frame images. Each frame video data is decoded according to the type sequence (for example, I, B, P, I, B, B, P, etc.) or is used for image display, etc.

If the type of the frame image data that is processed at specific time is inconsistent with the type of frame image data that shall be processed, it can be judged the video data has an error, i.e. there is a frame image data missing. For example, at time T, B-frame shall be processed, but actually P-frame is to be processed, then it can be judged that the video data has at least one B-frame image data missing.

The premise of adopting the aforesaid solution is the respective GOPs have uniform and regular data structures, so that each frame image data can be decoded or displayed in a fixed type sequence. However, the processing sequence of the frame image data in GOPs is always variable, even if the common program scene conversion will cause a change in respective frame image type sequences of GOPs. Therefore, such solution cannot meet the requirements of error detection and correction of video data and determine an amount of missing frames.

Therefore, it needs to provide a method of detecting video data errors to detect whether there is a frame image data missing in the video data and the amount of the missing data. This method is used for error correction of video data and can restore the missing data efficiently and improve the playing back effect.

### OBJECT AND SUMMARY OF THE INVENTION

An object of the invention is to provide a method and apparatus for detecting video data errors for overcoming the shortcomings in the prior art.

According to an embodiment of the invention, a method of detecting video data errors is provided, said video data including a plurality of successive frame image data, said method comprising the steps of: acquiring the processing sequence information of two frame image data in said video data, said two frame image data being immediately adjacent in the processing sequence; determining the processing sequence information difference between said two frame image data; comparing said information difference with a reference value; and judging, based on said comparison result, whether there is a frame image data missing between two frame image data.

A video data error correction method as provided by the invention includes the step of detecting video data errors, and the step of correcting and restoring the missing data based on the detection result.

According to an embodiment of the invention, an apparatus for detecting video data errors is provided, said video data including a plurality of successive frame image data, said apparatus comprising: acquiring means for acquiring the processing sequence information of two frame image data of said video data, said two frame image data being immediately adjacent in the processing sequence; determining means, for determining the processing sequence information difference between two frame image data; comparing means, for comparing said information difference with a reference value; and judging means for judging, based on said comparison result of said comparing means, whether there is a frame image data missing between said two frame image data.

A video data error correction apparatus as provided by the invention includes means for detecting video data errors, and a data correction means for correcting and restoring the missing data based on the detection result.

Said frame image data comprise I-frame image data, B-frame image data, or P-frame image data, etc. Said processing sequence information includes time sequence information, or address sequence information. Said information difference includes a time sequence difference or address information difference between two immediate adjacent frame image data. Said reference value is a processing sequence information difference between two immediate adjacent frame image data in a specific video format.

Said comparison result comprises a ratio or a difference between said information difference and said reference value, and can be used to determine which one of said information difference and reference value is greater and the multiple relationships between them. If said information difference is equal to said reference value, there is no data missing between said two frame image data; otherwise, if said information difference is greater than said reference value, there is a frame image data missing between the two frame image data. The multiple relationships between the difference and reference value can determine the amount of the missing frame image data.

The method and apparatus for detecting video data errors provided by the invention can, not only judge whether there is a frame image data missing between the two immediate frames, but also determine the amount of the missing frame image data. Such method and apparatus can be applied more extensively because they are free from the restriction of type sequence of the frame image data.

Through the following description of the invention made with reference to the accompanying drawings and the claims, other objects and achievements of the invention will become obvious, and a complete understanding of the invention will be obtained.

### BRIEF DESCRIPTION OF THE DRAWINGS

The invention will be further described in detail through embodiments and with reference to the accompanying drawings.

FIG. 1 is a flow chart of a video data error correction method according to an embodiment of the invention;

FIG. 2 is a block diagram of a video data error correction apparatus according to an embodiment of the invention; and

FIG. 3 is a block diagram of an optical disc playing apparatus according to an embodiment of the invention.

In all the drawings, the same reference sign represents the same, similar or corresponding feature or function.

### DETAILED DESCRIPTION OF THE INVENTION

The concept of the invention is: each video frame image data includes a specific processing sequence, such as the decoding time information, etc. According to the motion picture compression standard (for example, MPEG-2), among the video data in a specific format, the difference between the processing sequence information (for example, time information, etc.) of two immediate frame images, one after the other, is a fixed value. If the processing sequence difference between two immediate frame image data, one after the other, in a segment of video data is not equal to the fixed value, there is a frame image data missing between the two frame image data. A comparison between the difference and fixed value may determine the amount of the missing frame image data.

If the difference is twice the fixed value, there is a frame image data missing between the two frames; if the difference is triple the fixed value, there are two frame image data missing between the two frames. According to the prior art, the method like motion vector estimation can restore the missing frame image data and thereby improve the playing effect.

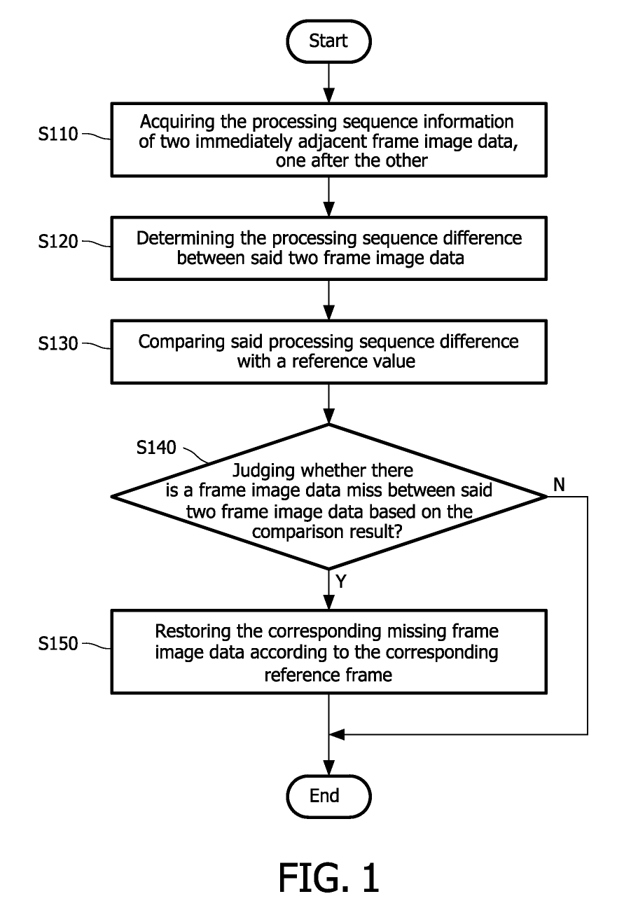

FIG. 1 is a flow chart of a video data error correction method according to an embodiment of the invention. Firstly, the processing sequence information of two frame image data immediately adjacent in processing sequence, one after the other, is acquired in the video data stream (Step S110). The video data stream may be the optical disc program video data read from the optical disc, or the video data received from the digital broadcast.

Each frame image data comprises several data packages. For example, in the technical standard of Blu-ray Disc BD, the code rate for the video sequence of 720×576, frame per second is about 5 Mbps, whereas each I-frame image data includes 442.8 data packages, each P-frame image data includes 198 data packages, and each B-frame image data includes 68.4 data packages. In general, the head information of each data package comprises the processing sequence information of this frame image data.

The processing sequence information includes a Decoding Time Stamp DTS to determine the decoding time sequence of the frame image data, it may also include a Presentation Time Stamp PTS to determine the presentation time sequence of the frame image, etc.

Secondly, the difference between the processing sequence information of said two frame image data is determined (step S120). The difference between the processing sequence information (for example, decoding time information) of said two frame image data may be a difference between the decoding sequence time, or a difference between the presentation sequence time, and if the data is read from the optical disc, it may also include the difference between the storage address information, etc.

In general, the Decoding Time Stamp DTS of a frame image data is determined according to the Picture Sync Time Stamp PSTS, while the PSTS is locked according to the Program Clock Reference, so the DTSᵢ of the ith frame image data may be represented by the locked PSTSᵢ.

As shown in equation (1), the Decoding Time Stamp DTSᵢ of a frame image is equal to PSTSᵢ plus a reference offset T_{d}. T_{d} is associated with the reference clock of a decoder and is a fixed value.

DTSᵢ=PSTSᵢ+T_{d} (1)

Correspondingly, the Decoding Time Stamp difference of two immediate frame images, one after the other, is represented as equation (2).

ΔDTSᵢ=DTSᵢ−DTSᵢ₋₁=PSTSᵢ−PSTSᵢ₋₁ (2)

Then, comparing said processing sequence difference with a reference value (Step S130). In a specific video data format, the difference PSTSᵢ−PSTSᵢ₋₁ of the DTS between two successive frame images, one after the other, is only associated with the video format. For a video format, PSTSᵢ−PSTSᵢ₋₁ is a fixed value F. Said reference value may be set as the fixed value F.

The numerical value relationship between PSTSᵢ−PSTSᵢ₋₁ and F can be obtained by comparison. For example, PSTSᵢ−PSTSᵢ₋₁=F, or PSTSᵢ−PSTSᵢ₋₁>F, or PSTSᵢ−PSTSᵢ₋₁=nF, n (n is an integer greater than 1) times of F, etc.

Next, judging whether there is a data missing between said two frame image data based on the comparison result (Step S140). If PSTSᵢ−PSTSᵢ₋₁=F, it can be judged that there is no frame image data missing between said two frame image data, i.e. the two frame image data are successive.

If PSTSᵢ−PSTSᵢ₋₁>F, it is judged that there is a frame image data missing between said two frame image data, i.e. it is detected that the video data has data errors. Further, if PSTSᵢ−PSTSᵢ₋₁=nF (n is an integer greater than 1), it can be judged that there are (n−1) frame image data missinges between said two frame image data.

Finally, if there is a frame image data missing, restoring the missing frame image data by the data recovery or correction method (step S150). In the prior art, the missing frame image data can be restored to a certain extent by the motion vector estimation method and with reference to the adjacent frame image. The video data error correction method provided by the invention comprises the steps of the method of detecting video data and the data recovery and correction steps.

Through the method of detecting video data errors and the method of correcting video data errors as provided by the invention, it can be judged whether there is a frame image data missing between the two immediate frames, one after the other, and the data amount of the missing frame image data can also be determined, furthermore, the missing data can be restored and corrected, these are free from the affect of the scene change in the image program.

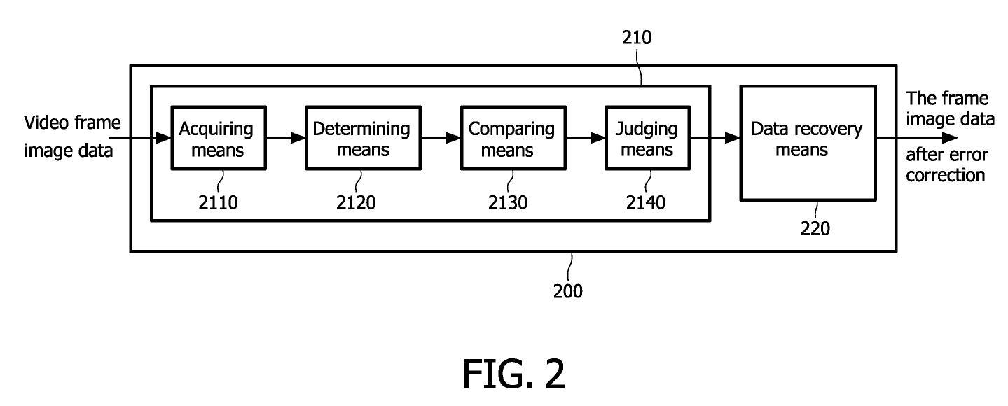

FIG. 2 is a block diagram of the video data error correction apparatus 200 according to an embodiment of the invention. The video data correction apparatus 200 provided by the invention comprises a video data error detection means 210 for detecting the frame image data missing errors in the video data, and a data restore means 220 for restoring the detected data missing errors according to the detection result.

Means 210 includes an acquiring means 2110 for acquiring the processing sequence information of two immediately adjacent frame image data, one after the other, in the processing sequence among the video data stream.

The data package of each frame image data includes the processing sequence information of said frame image data. The processing sequence information generally comprises DTS information for determining the decoding sequence and PTS information for determining the presentation sequence, etc.

Means 210 further comprises a determining means 2120 for determining, based on the acquired processing sequence information, the difference between the processing sequence information of two frame image data. The difference between the processing sequence information of two frame image data can be a difference of decoding sequence time, and a difference of presentation sequence time, or a difference between storage address information, etc.

Means 210 further includes a comparing means 2130 for comparing said processing time sequence difference with a reference value. For a video format, the processing sequence difference between two frame image data is a fixed value F, the two frame image data being immediately adjacent in processing sequence, one after the other, so F can be taken as a reference value to compare with the processing sequence information difference of two adjacent frame image data among the processed video data. The correspondence relationship between PSTSᵢ−PSTSᵢ₋₁ and F can be obtained after comparison. For example, PSTSᵢ−PSTSᵢ₋₁=F, PSTSᵢ−PSTSᵢ₋₁>F, or PSTSᵢ−PSTSᵢ₋₁=nF, n (n is an integer and n>1) times of F, etc.

Means 210 further comprises a judging means 2140 for judging, based on the comparison result of means 230, whether there is a frame image data missing between two frame image data. If PSTSᵢ−PSTSᵢ₋₁=F, it can be determined that there is no frame image data missing between said two frame image data, i.e. the two frame image data are successive.

If PSTSᵢ−PSTSᵢ₋₁>F, it can be judged that there is a frame image data missing between said two frame image data, i.e. it is detected that the video data has data errors. Further, if PSTSᵢ−PSTSᵢ₋₁=nF, it can be judged that there are (n−1) frame image data missinges between said two frame image data.

Through the apparatus for detecting video data errors and apparatus for correcting video data errors as provided by the invention, it can be determined whether there is a frame image data missing between the two immediate frame image data, one after the other, and the data amount of the missing frame image data can be determined, these are free from the affect of the scene change of programs.

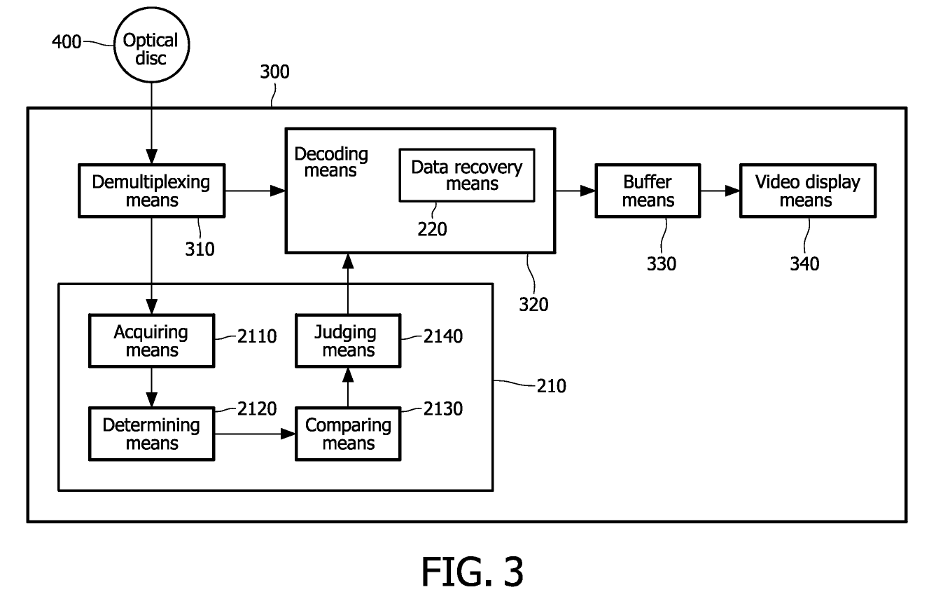

FIG. 3 is a block diagram of an optical disc playing apparatus according to an embodiment of the invention. FIG. 3 includes a schematic diagram of an optical disc playing apparatus 300 and a schematic diagram of optical disc 400.

The optical disc playing apparatus 300 comprises a demultiplexing means 310 for demultiplexing the data read from the optical disc 400 into corresponding video or audio data.

Apparatus 300 further includes a video data error detection means 210 for detecting the frame image data missing errors in the video data. Means 210 includes an acquiring means 2110, a determining means 2120, a comparing means 2130 and a judging means 2140, each means is identical with or similar to that having corresponding reference sings as shown in FIG. 2.

Apparatus 300 also comprises a decoding means 320 for decoding the video data and audio data. The decoding means 3200 includes a data recovery means 250 for data recovering and correcting the missing errors of the frame image data as detected by means 210.

Apparatus 300 further comprises a buffer means 330 for buffering the program playing data. Apparatus 300 also includes a video display means for displaying the video data transmitted from the buffer means 330, etc.

According to the optical disc playing apparatus provided by the invention, through detection and recovery of the missing frame image data, the playing effect of the optical disc is improved, and the playing of the optical disc is free from the affect of the program playing scene change or a GOP data structure.

Although the invention is described above in combination with embodiments, apparently it is obvious that those skilled in the art are able to make various alternations, modifications and changes based on the contents described above. Therefore, such alternations, modifications and changes shall come within the scope of spirit and range of the appended claims of the invention.

1. A method of detecting video data errors, said video data comprising a plurality of successive frame image data, said method comprising the steps of:
acquiring the processing sequence information of two frame image data in said video data, said two frame image data being immediately adjacent in the processing sequence, one after the other;
determining the processing sequence information difference between said two frame image data;
comparing said information difference with a reference value; and
judging, based on said comparison result, whether there is a frame image data miss between said two frame image data.

2. According to the method recited in claim 1, wherein said processing sequence information includes time sequence information.

3. According to the method recited in claim 1, wherein said information difference comprises a time sequence difference between said two immediate frame image data, one after the other.

4. According to the method recited in claim 1, wherein said processing sequence information comprises address sequence information.

5. According to the method recited in claim 1, wherein said processing sequence difference includes an address information difference between two immediate frame image data, one after the other.

6. According to the method recited in claim 1, said comparison result comprises the difference relationship between said information difference and said reference value.

7. According to the method recited in claim 1, said comparison result comprises the proportional relationship between said information difference and said reference value.

8. According to the method recited in claim 1, said reference value is the difference between the processing sequence information of two immediate frame image data, one after the other, in a specific video format, said video data having said specific video format

9. A video data error correction method, said video data comprising a plurality of successive frame image data, the method comprising the steps of:
acquiring the processing sequence information of two frame image data in said video data, said two frame image data being immediately adjacent in the processing sequence, one after the other;
determining the processing sequence information difference between two frame image data;
comparing said information difference with a reference value;
judging, based on said comparison result, whether there is a frame image data miss between said two frame image data; and
according to said judging result, if said video data has a frame image data miss, recovering said missing frame image data according to a data recovery and correction method.

10. According to the method recited in claim 9, wherein said processing sequence information includes time sequence information.

11. According to the method recited in claim 9, wherein said reference value is the processing sequence information difference between two immediate frame image data, one after the other, in a specific video format, said video data having said specific video format.

12. An apparatus for detecting video data errors, said video data comprising a plurality of successive frame image data, said apparatus comprising:
acquiring means, for acquiring the processing sequence information two frame image data of said video data, said two frame image data being immediately adjacent in the processing sequence, one after the other;
determining means, for determining the processing sequence information difference between two frame image data;
comparing means, for comparing said information difference with a reference value; and
judging means, for judging, based on said comparison result of said comparing means, whether there is a frame image data miss between two frame image data.

13. According to the apparatus for detecting video data errors recited in claim 12, wherein said processing sequence information comprises time sequence information.

14. According to the apparatus for detecting video data errors recited in claim 12, wherein said reference value is the processing sequence information difference between two immediate frame image data, one after the other, in a specific video format, said video data having said specific video format.

15. A video data error correction apparatus, said video data comprising a plurality of successive frame image data, said apparatus comprising:
acquiring means, for acquiring the processing sequence information of two frame image data in said video data, said two frame image data being immediately adjacent in the processing sequence, one after the other;
determining means, for determining the processing sequence information difference between said two frame image data;
comparing means, for comparing said information difference with a reference value;
judging means, for judging, based on said comparison result of said comparing means, whether there is a frame image data miss between two frame image data; and
a data recovery means for recovering, according to said judging result, said missing frame image data according to a data recovery and correction method if said video data has a frame image data miss.

16. According to the video data error correction means recited in claim 15, wherein said processing sequence information comprises time sequence information.

17. According to the video data error correction means recited in claim 15, wherein said reference value is the processing sequence information difference between two immediate frame image data, one after the other, in a specific video format, said video data having said specific video format.
